(19) United States
(12) Patent Application Publication
(10) Pub. No.: US 2012/0296623 A1
(43) Pub. Date: Nov. 22, 2012

(54) MACHINE TRANSPORT AND EXECUTION OF LOGIC SIMULATION

(75) Inventor: JERROLD LEE GRAY, WOODINVILLE, WA (US)

(73) Assignee: GRAYSKYTECH LLC, WOODINVILLE, WA (US)

(21) Appl. No.: 13/476,000

(22) Filed: May 20, 2012

Related U.S. Application Data
(60) Provisional application No. 61/488,540, filed on May 20, 2011.

(51) Int. Cl. G06F 17/50

(52) U.S. Cl. 703/15

(57) ABSTRACT

A processing architecture and methods are disclosed in which a simulation state vector can be contained in a common memory, formatted in a known form, distributed in a deterministic bus to a sea of logic processors, and returned to the common memory through the deterministic bus.

### CROSS REFERENCE TO RELATED APPLICATIONS

Priority is claimed to U.S. Provisional Application No. 61/488,540, filed May 20, 2011, entitled “MACHINE TRANSPORT AND EXECUTION OF LOGIC SIMULATION”, which is incorporated by reference.

### BACKGROUND

This disclosure relates to the field of model simulation and more specifically to methods of data distribution and distributed execution that enable the design and execution of superior machines used in logic simulation.

Most logic simulation is performed on conventional CPU based computers ranging in size and power from simple desktop computers to massively parallel super computers. These machines are typically designed for general purposes and contain little or no optimizations that specifically benefit logic simulation.

Many computing systems (including DSPs and embedded micro controllers) are based on a complex machine language (assembly and/or microcode) with a large instruction set commensurate with the need to support general-purpose applications. These large instruction sets reflect the general-purpose need for complex addressing mode, multiple data types, complex test-and-branch, interrupt handling and use of various on-chip resources. Digital Signal Processors (DSP) and Central Processing Units (CPU) provide generic processors that are specialized with software (high-level, assembly or microcode).

There have been previous attempts to create faster processing for specific types of data, for example the Logic Processing Unit (LPU). The LPU is a small Boolean instruction set with logic variables based on 2-bit representations (0, 1, undefined, tri-state). However, there were processing shortcomings in the LPU since it is still a sequential machine performing one instruction at a time and on one bit of logic at a time.

More specific types of numerical processing, for example logic simulation, have utilized unique hardware to achieve performance in specific analysis. While this is effective for processing or acting on a given set of data in a time efficient manner, it does not provide the scalability required for the very large models needed today and even larger in the future.

One of the shortcomings of current computing systems is the lack of machine optimizations of Boolean logic within the general CPUs. The combined lack of specialized CPU instructions and a desire to off-load CPU processing has lead to an explosion of graphics card designs over the years. Many of these graphics cards have been deployed as vector co-processors on non-graphic applications merely due to the nature of the types of data and graphic card machine processing being similar.

Data types defined by IEEE standards for logic are based on an 8-bit representation for both a logic node or storage within VHDL, Verilog as well as other HDLs. Many simulation systems have means of optimizing logic from 2 to 4 bits to make storage and transport more efficient. Yet, CPUs cannot directly manipulate these representations since they are not “native” to the CPU and they have to be calculated with high or low level code.

Logic synthesis tools from various tool providers have demonstrated that arbitrary logic can be represented by very small amounts of data. This is evidenced by the fact that all these tools can successfully target all families of FPGAs and ASICs, which are based on very simple logic primitives.

HDL compilers often generate behavior models for simulation and logic structures for synthesis. Simulation behavior models are a part of the application layer which are built from some high level language which is independent of machine form, but whose throughput is totally dependent on the CPU machine, the machine language and the operating system.

Logic simulation across multiple PC platforms is not practical and current simulation software cannot take advantage of multiple core CPUs.

In multiple core CPUs, the individual cores support very large instruction sets and very large addressing modes and, although they share some resources, are designed to work independently. Each core consumes an enormous amount of silicon are per chip so that CPUs found in common off-the-shelf PCs can only contain 2 to 8 cores.

Chips exist containing cores that number much greater than 8 (for example, currently the 256 processors in the Raport chip is the largest), these are more or less designated for embedded applications or functions peripheral to a CPU. These individual cores are still rather complex general-purpose processors on the scale of 8-bit and 16-bit processors in the early days of the first microprocessors (8008, 8085, 8086, etc.) with smaller address space.

### SUMMARY

A multiplicity of superior computing engines, data transports and storage starts with a redefinition of logic data, as well as a redefinition of logic data transport, expression and execution. Improved data and functional definition and the development of superior machines does not necessarily require a re-definition of the host CPU, but can be more easily, and perhaps more efficiently, be applied in peripheral design.

Simulation can be understood as a cyclic process of calculating the next state of a model based on the current state and inputs to the system. In logic systems the state of a model may be referred to as the “state vector”. The “current state vector” is defined as current state of all the logic storage elements (flip-flops, RAM, etc.) that are present in the model.

Logic simulation can be understood as a “discrete” calculation of logic state vectors, wherein “cycle based” or Boolean calculations are performed without respect to logic propagation delays and “real time” calculations account for these delays. Combined cycle based and real time calculations in a single simulation are referred to as “mixed mode” although in some contexts this term has been extended to include continuous modeling such as found in SPICE.

Processing of a primitive portion of the state vector (a single memory element) can be accomplished with a simple set of rules. Bits and words can be processed with a small instruction set on a logic specific processor core much smaller in silicon area than those described above, such that chips built from this technology could contain thousands of cores.

These RAM based cores can be configured with conventional machine language code augmented by RAM based synthetic machine instructions compiled from the customers source code HDL. This enables the core to efficiently emulate one or more pieces of the overall model to a high level of efficiency and speed.

The deterministic nature of simulation allows for the use of deterministic methods of connecting arrays of logic processors and memory. These deterministic methods are usually defined as “buses” rather than “networks” and techniques are generally referred to as “data flow”. These are considered tightly coupled systems of very high throughput.

In some embodiments, physical data flow architectures described herein can be configured to distribute state vectors from a core of common memory to one or more arrays of processors to compute the next state vector, which is returned to the core of common memory.

Some embodiments may be configured to use logic specific Von Neuman processors to compute portions of the next state in the context of the aforementioned arrays.

Some embodiments may be configured to provide a compact “true logic” Sum Of Product (SOP) representation of the logical Boolean formulas relating combinatorial inputs to output in any logic tree.

Some embodiments may be configured to facilitate algorithmically reduced synthesized logic by utilizing a SOP form of logic representation in machine code compatible with aforementioned logic specific processors. This form and machine operation supports input and output inversions and simultaneous computation of multiple inputs and outputs.

Some embodiments may be configured to provide efficient notation for positive and negative edge propagation such that machine code can calculate delays in the combinatorial data path for “real-time” logic processors.

Other features, objects and advantages of this disclosure will become apparent from the following description, taken in connection with the accompanying drawings, wherein, by way of illustration, example embodiments of the invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram of an example computing system with a simulation engine included.

FIG. 2 is a block diagram of an example simulation engine PCI plug-in card with logical modules.

FIG. 3 is a block diagram of an example Boolean Logic ASP and its integration with a VSS bus.

FIG. 4 is an example set of tables illustrating a definition of a state vector element and a composite state vector used for data storage and transport.

FIG. 5 is an example set of tables illustrating a definition of the Logic Expression Table used to define synthesized logic models for simulation.

FIG. 6 is a block diagram of example components that make up a PTLC and their interaction.

FIG. 7 is a block diagram of an example Real Time Logic ASP and its integration with a VSS bus.

FIG. 8 is a flow chart of an example simulation cycle from a host software perspective.

FIG. 9 presents a pie chart of a mixed mode model.

### DETAILED DESCRIPTION

Detailed descriptions of various embodiments are provided herein. Specific details disclosed herein are not to be interpreted as limiting, but rather as a basis for the claims and as a representative basis for teaching one skilled in the art to employ the present invention in virtually any appropriately detailed system, structure or manner.

Embodiments of this disclosure may provide a simulation state vector that can be partially or completely contained in common memory, can be formatted in a known form, distributed in a deterministic bus to a sea of logic processors and returned to the common memory through the same or similar deterministic bus.

A deterministic bus may be characterized as a bus which has no ambiguity of content at any time or phase. Whether parallel and/or serial content is determined by properties like time slots, delimiters, pre-defined formats, fixed protocols, markers, flags, IDs and chip selects. Although there may be error detection/correction there is no point-to-point control, handshaking, acknowledgements, retries nor collisions. An example of “deterministic” is a microprocessor memory bus where by Ethernet is not. The significance of including a deterministic bus is that a deterministic bus can be designed such that the actual sustainable data transfer rate is nearly the full bandwidth of the physical bus itself. To create a simulation architecture of maximum speed for an applied RAM and bus construction, it is prudent to use the highest bandwidth forms of both.

In one embodiment the memory, bus and processing arrays may be designed with a high bandwidth data-flow such that a current state vector in common memory flows to the processor arrays and back as the next state vector to common memory in minimal time with little or no external software intervention. This reduces the simulation cycle time to a time it takes to read each element of current state once from common memory, the computation of each next state element and the writing of each element of the next state to common memory.

In many forms of deterministic buses, such as daisy-chained FIFOs, there is no theoretical limit to the number of processors in the array. It is possible to turn all computationally limited simulations into I/O limited simulations by supplying enough processors in an array. In a practical system there may be a balance struck between I/O and computation time.

The actual organization of memory, buses and processors is highly dependent on the simulation goals of the simulation environment designers. As described herein, a system designer can create a system wherein the speed of simulation is driven by the speed of memory and bus. Since this usually has a cost and performance consequence depending on choices, the exact implementation depends on overall system's goals.

Further embodiments may provide high-end applications that can involve massive parallel simulation of logic processors on deterministic buses that extend across multiple circuit boards contained on and interconnected by motherboards or backplanes. This involves simulation modeling of very large multiple chip systems such as an entire PC motherboard.

Even further embodiments may provide a PC plug-in peripheral card and may be accessible to a more conventional simulation environment of hardware engineers.

Whether large or small embodiments, the cyclic behavior described above for state vector data emulates a repetitive “circuit” of data in the same sense that a telephone “circuit” repeats transporting voice signals along the same physical path. Simulation software in the host computer is responsible for definition and set up of these vector paths but plays no role what-so-ever in the actual transport.

The “little” software intervention also cited above is directed at software needed to deal with either modular pieces excluded from the main model, extra non-model features such as breakpoints and exceptions, and synchronization. The significance of this is that as the model grows in size host management of the overall system grows to set up the system, but does not grow with execution of the system. A clarifying analogy would be to think of the host's responsibilities for a chip simulation is at the chip's pins (pin counts in hundreds) and the modeling covering the internal gates (counts of a few hundred to many millions).

Unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present disclosure may be stored on a variety of computer-readable media including hard drives, compact disks, digital video disks, computer servers, integrated memory storage devices and the like.

Any combination of data storage devices, including without limitation computer servers, using any combination of programming languages and operating systems that support network connections, is contemplated for use in the present inventive method and system. The inventive method and system are also contemplated for use with any communication network, and with any method or technology, which may be used to communicate with said network.

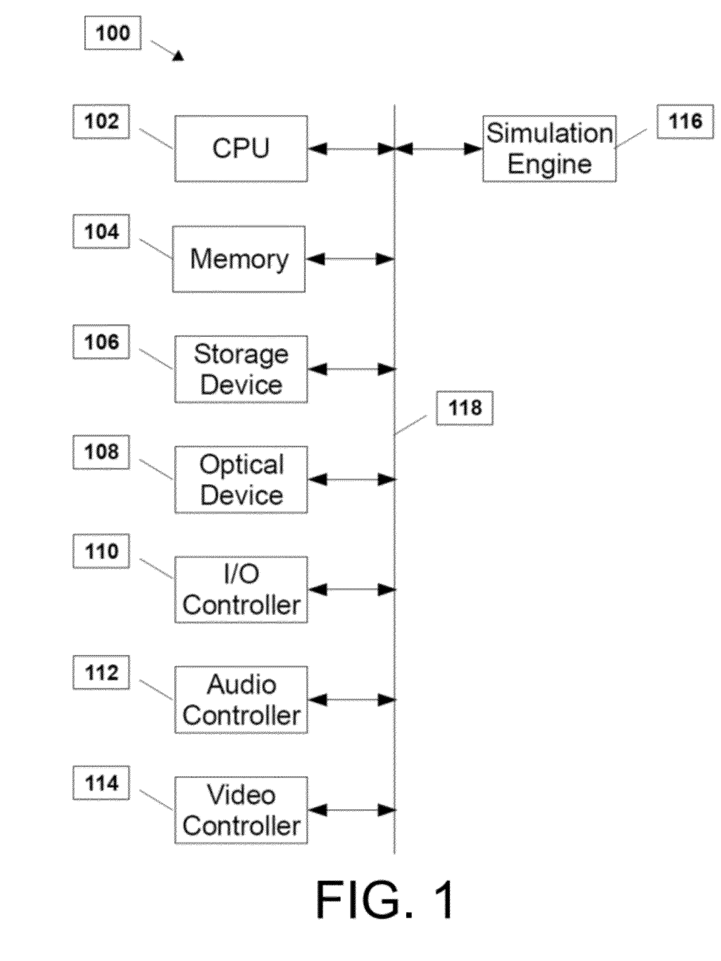

FIG. 1 is a block diagram of an example computing system with a simulation engine included, to provide an example simulation host PCI environment. FIG. 1 includes a computing device 100 which comprises a CPU 102, a memory 104, a storage device 106, optical device 108, I/O controller 110, audio controller 112, video controller 114 and a simulation engine 116 sharing a common bus 118.

In FIG. 1 the CPU 102, memory 104, storage device 106, optical device 108, I/O controller 110, audio controller 112, video controller 114 and simulation engine 116 are coupled to the bus 118. The CPU 102 is configured to use the simulation engine 116 as part of the overall simulation environment. Either as a server or a client application, the host CPU software is configured to provide and manage the necessary simulation resources needed by the model. This software also supports I/O elements of the simulation commonly known as the “test fixture”.

In FIG. 1 the CPU 102 may comprise, for example, one or more of a standard microprocessor, microcontroller, and/or digital signal processor (DSP). The present invention is not limited to the implementation of the CPU 102 though it is configured to use the simulation engine 116. The memory 104 may also be implemented in a variety of technologies. The memory 104 may comprise one or more of Random Access Memory (RAM), Read Only Memory (ROM), and/or a variant standard of RAM. For the sake of convenience, the different memory types outlined are illustrated in FIG. 1 as memory 104. The memory 104 provides instructions and data for processing by the CPU 102. In the illustrated embodiment, the components of system 100 are resident on a computer server; however, those components may be located on one or more computer servers, virtual or cloud computing services, one or more user devices (such as one or more smart phones, laptops, tablet computers, and the like), any other hardware, software, and/or firmware, or any combination thereof.

In FIG. 1 system 100 also has a storage device 106 such as a hard disk for storage of an operating system, program data and applications. System 100 may also include an Optical Device 108 such as a CD-ROM or DVD-ROM. System 100 may also comprise an Input/Output (I/O) Controller 110, configured to support devices such as keyboards and cursor control devices. Other controllers usually in system 100 are the audio controller 112 for output of audio and the video controller 114 for output of display images and video data alike. The simulation engine 116 is added to the system through the bus system 118.

The components in FIG. 1 described above are coupled together by a bus system 118. The bus system 118 may include a data bus, address bus, control bus, power bus, proprietary bus, or other bus. The bus system 118 may be implemented in a variety of standards such as PCI, PCI Express, AGP and the like.

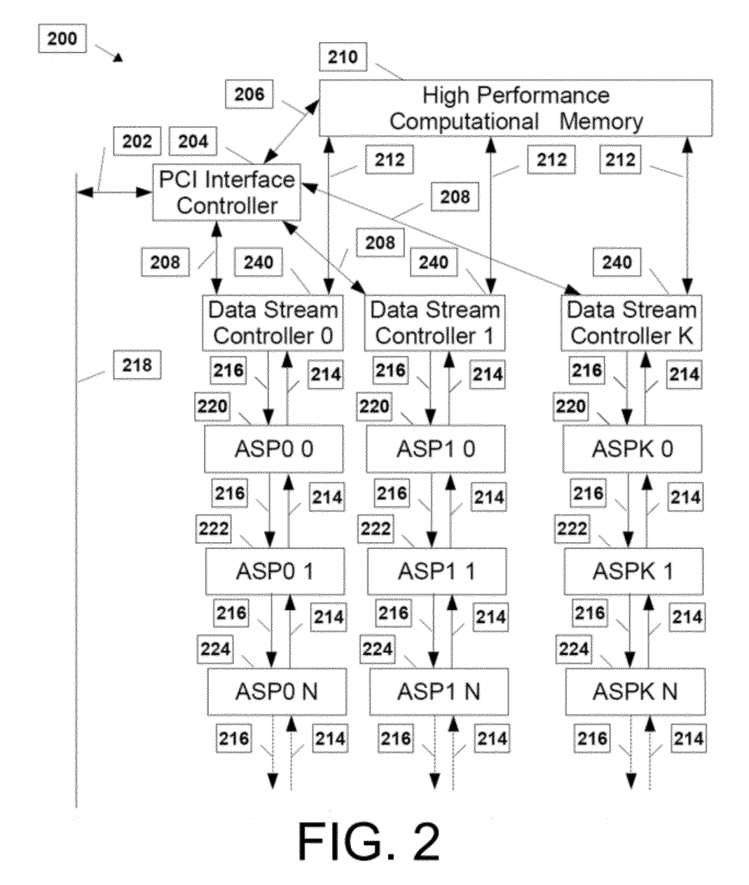

FIG. 2 contains a simulation engine 200 which includes an interface 202 to the host bus 218, a bus controller 204, high performance memory 210, data stream controllers 240, first level Application Specific Processors (ASP) 220, second level ASPs 222, and Nth level ASPs 224. FIG. 2 also illustrates various transactions 206 with bus controller 204 and memory 210, transactions 208 with bus controller 204 and data stream controllers 240, transactions 212 with data stream controllers 240 and high performance computational memory 210, outbound data streams 216 and inbound data streams 214.

In FIG. 2 is shown a parallel instantiation of K numbered data stream controllers 240, each sharing access to high performance computational memory 210, each supporting an array of N ASPs, and each under the coordination of the bus interface controller 204. The bus interface controller 204 may be a simple state machine or a full blown CPU with its own operating system. The data stream controllers 240 may be simple direct memory access (DMA) devices or include memory management functions (scatter/gather) needed to get I/O between data stream controllers. By definition of being small and specific, the ASPs are all alike. The possible exception is the first level ASP 220 and Nth level ASP 224 may contain special provisions for being at the ends of an array. One feature used in one embodiment of the last level ASP 224 was to provide a “loop back” function so that the outbound bus was joined to the inbound bus.

In FIG. 2 is shown one embodiment of the logical modules of the simulation engine (SE) within a PCI card. For direct control the computational memory 210, controls and status can be mapped into the PC's addressable memory space 104. As described above, this memory is referred to as “common memory”. The computational memory 210 contains the current and next state vectors of the simulation cycle. Contiguous input data and contiguous output data would be sent to the SE from the application from a hard disk 106, or system memory 104. The data and delimiters are written in transactions 206 to computational memory 210 and are managed by the application executing on the system 100. During initialization, ASP instructions and variable assignment data images are written by transactions 206 into computational memory 210 for later transfer by the Data Stream Controller (DSC) 240.

Prior to a computational cycle, new inputs are written 206 to the computational memory 210. The inputs may be from new real data or from a test fixture. After the computational cycle newly computed values can be read out 206, 202 for final storage.

The application can interact with the DSC controller 240 to trigger the next computation or respond, by interrupt to the completion of the last computation or the trigger of a breakpoint. In this embodiment the DSC controller 240 is a specialized DMA controller with provisions for inserting certain delimiters and detecting others of its own. It is responsible for completing each step in the cycle but the cycle is really under control of the host software.

The outbound data bus 216 is new initialization or new data for processing by one of the ASP's chain. The inbound data bus 214 is computed data from the last computational cycle or status information. During initialization it also provides information on the ASP types that are a part of the overall system. The inbound and outbound buses connect all ASP modules whether they are all in the same chip or split up among many chips. The last physical ASP in the chain contains un-terminated connections (indicated by dashed lines).

In this embodiment the PCI bus 202 can be PCIe version 1.1, 2.0 or 3.0, or any later developed version. The latter versions are backward compatible with PCIe version 1.1, and all are non-deterministic given they rely on a request/acknowledgement protocol with approximately a 20% overhead. Though some standards versions are capable of 250 MB/s, 500 MB/s and 1 GB/s respectively, this may be too slow for the host memory to act as “common” memory in some embodiments.

Computational memory 210 may be compatible with host interface 204. Computational memory 210 may comprise, e.g., a 64-bit wide memory. The data width of the common memory depends on requirements, but is not restricted by the host interface to 64-bit. The same memory pool can be configured to appear as 64-bit on the host port and 128-bit or 256-bit (or whatever is required) on the DSC 240 ports. With DDR2 and DDR3 SDRAM memory data transfer rates of 8.5 GB/s and 12.8 GB/s respectively, it is likely that common memory at 64-bit will be able to support more than one DSC 240 and 128-bit or 256-bit wide memory could support many DSCs.

Further, the system can use high performance memory 210 to service more than one array of processors. High-performance memory 210 will ensure that the array system does not become I/O limited.

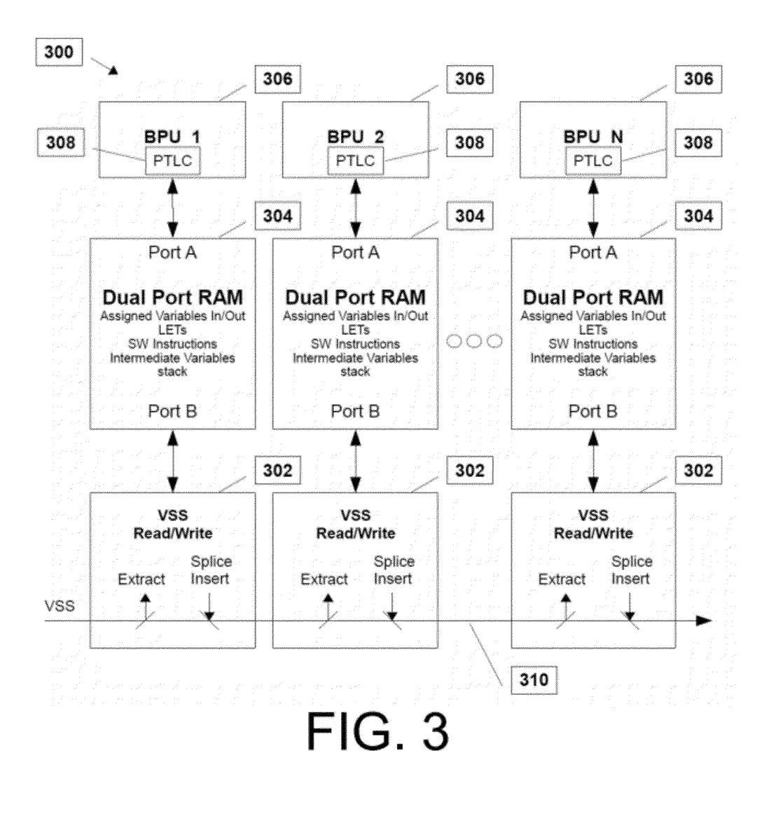

FIG. 3 contains an ASP array 300 comprised of N copies (3 shown) and contains Vector State Stream (VSS) read/write 302, dual port RAM 304, Boolean Processor Unit (BPU) 306, Product Term Latching Comparator (PTLC) 308 within the BPU and connected to the VSS 310.

In FIG. 3, the BPU 306 may comprise a conventional Von Neumann processor executing machine instructions from dual port RAM 304. The BPU 306 contains the PTLC 308 which can be designed to use dual port RAM 304 directly or utilized its own private RAM block (not shown). Like other Von Neumann processors, the BPU 306 contains data move instructions to transact data between the PTLC 308 and dual port RAM 304. The BPU 306 also contains a unique instruction to invoke the PTLC 308 state machine to process N entries of synthesized data in dual port RAM 304. This set of synthesized data in conjunction with the instruction for PTLC execution comprises a synthetic machine instruction. Though the number of data move instructions are hard coded into the BPU 306, the number of synthetic machine instructions is only limited by memory size. Each BPU 306 can have the same or unique sets of synthetic machine instructions.

FIG. 3 shows breakdown of the logic ASP, which contains a deterministic bus called the Vector State Stream (VSS) 310, a module that interacts with the bus 302, a dual port RAM block 304 and the BPU 306. Contained within the BPU 306 is the Product Term Latching Comparator (PTLC) 308.

The VSS 310 bus contains the current state vector in the input phase and the next state vector in the output phase. It also contains delimiters that act as both commands and markers to denote data designated to each ASP. The VSS Read/Write module 302 may contains the sophistication to decode when to take inputs and when to produce outputs based on the delimiters in the stream. The VSS is only one of several design possibilities of producing a very low overhead and high bandwidth method to “split” up a large state vector into smaller components suitable in size for the ASP RAM. The VSS method puts more of the sophistication in the VSS Read/Write module 302 rather than any central controller, which allows the split management to scale with the number of ASPs in the system. It should be possible to manage state vectors with much less than 1% of the VSS bandwidth being used for delimiters.

The same mechanism used for a “split” function in the VSS can also be used to re-combine the computed output into the output stream. Other embodiments can do this without delimiters.

Notably, the vast majority of the bus bandwidth is used for propagation of vector data and that the overhead of routing data doesn't suffer from the scale of the number of ASPs used in the array.

Unlike other simulation environments, the state vector need not be completely abstracted from hardware. The state vector may be configured with a specific form in common memory. Non-memory storage elements in the simulation model may be mapped into compact locations in computational memory for efficient transfer to and from the ASP arrays. Memory elements may be configured to use a specialized ASP designed for memory modeling.

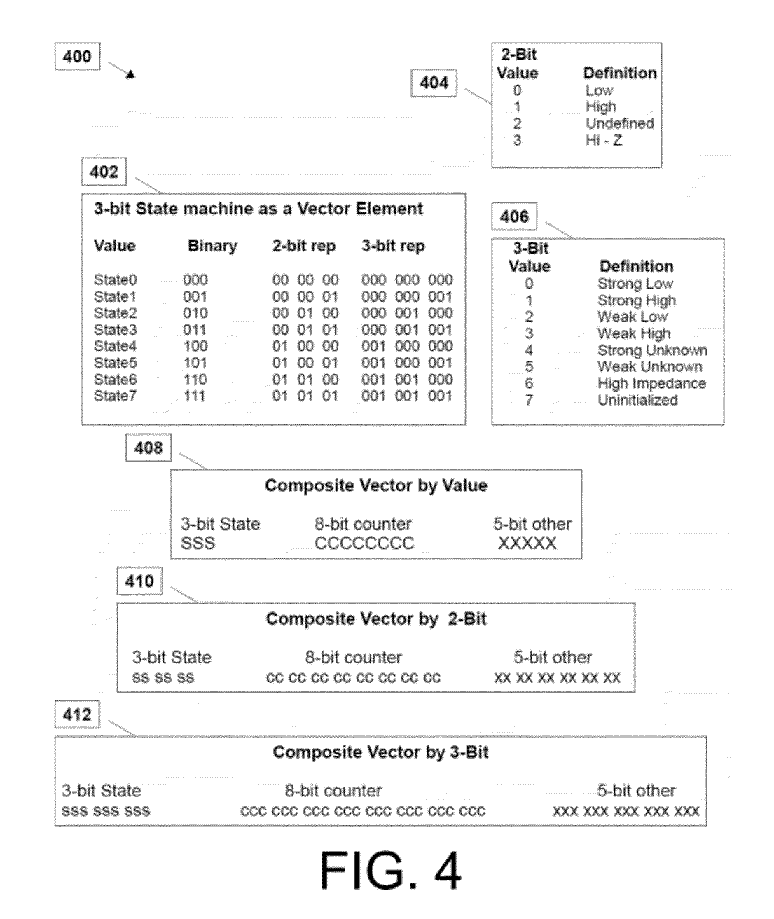

FIG. 4 contains data representations 400 for a 3-bit state machine as a vector element 402, 2-bit 404, 3-bit 406 as well as composite vectors by value 408, 2-bit 410 and 3-bit 412 representations.

In FIG. 4 is shown an example of a 3-bit state machine state definition 402 in terms of its symbolic value, single bit binary and actual 2-bit and 3-bit binary. A single bit only has two states so we cannot represent useful simulation states with a single bit. The choice of the correct actual binary may depend on the intent of the type of simulation. Most Boolean and real-time simulation can be handled with 2-bit representation 404, and the remainder can be handled with 3-bit representation 406. Embodiments of the system disclosed herein may work equally well in either case and this could be expanded to include greater than 3-bit representations. Since many models can be handled with 2-bit representation, and 2-bit representations generally correspond to the highest functional density and transport bandwidth, 2-bit representations are used in describing several of the representative embodiments herein.

IEEE representations for logic are 8-bit so a 32-bit word can contain only 4 variables. For cycle based simulation, only three states are needed so a 2-bit representation a 32-bit word can contain 16 variables. For more complex operations a 3-bit representation of logic may allow a 32-bit word to contain 10 variables. Utilizing a 2-bit or 3-bit transport and representation of logic supports dense functionality and high bandwidth transport and calculation of the underlying machines support it. Conventional CPUs cannot do independent logic evaluations on individual on 8-bit fields of a 32-bit word in single instructions. The PTLC can do concurrent evaluation of 16 inputs of a 32-bit word in a single synthetic machine instruction.

In many computer systems, variables are often located in memory on 8-bit, 16-bit, 32-bit and 64-bit boundaries. In embodiments of this disclosure, the “compiler” may be configured to pack small vector elements into a composite vector 408 as shown in FIG. 4. The example shown is typical for a small design module that contains a 3-bit state machine, a counter and 5 bits of other logic. The symbolic 16-bit composite vector may use 32-bits of storage 410 or 24-bits of storage 412 depending on simulation requirements.

In a high efficiency compilation environment, vector packing may be related to machine execution in addition to machine transport. Though the state vector represents the current or next state of memory elements, the state vector doesn't cover the combinatorial logic that connects the current state to the next state. Also included is a mechanism to cover combinatorial logic with a format very similar to state representation. For this reason, the compiler may organize packing for highest execution efficiency.

Another factor in the format of the state vector, and vector packing, is that the ASP's VSS Read/Write module 302 contains an ability to read or write multiple disjoint locations in the state vector as it flows by on the VSS 310. In simpler versions of this module this may involve greater coordination by the compiler and perhaps some run-time reformatting of a small percentage of the vector. In more sophisticated implementations, little or no coordination is necessary and the output vector could have an identical format to the input vector as well with no run-time intervention.

In some embodiments, the state vector may occupy a nearly contiguous block of locations in computational memory with only a few percent of unused space in the block. This reduces the actual memory I/O cycle between computational memory and the ASP arrays to close to the theoretical minimum.

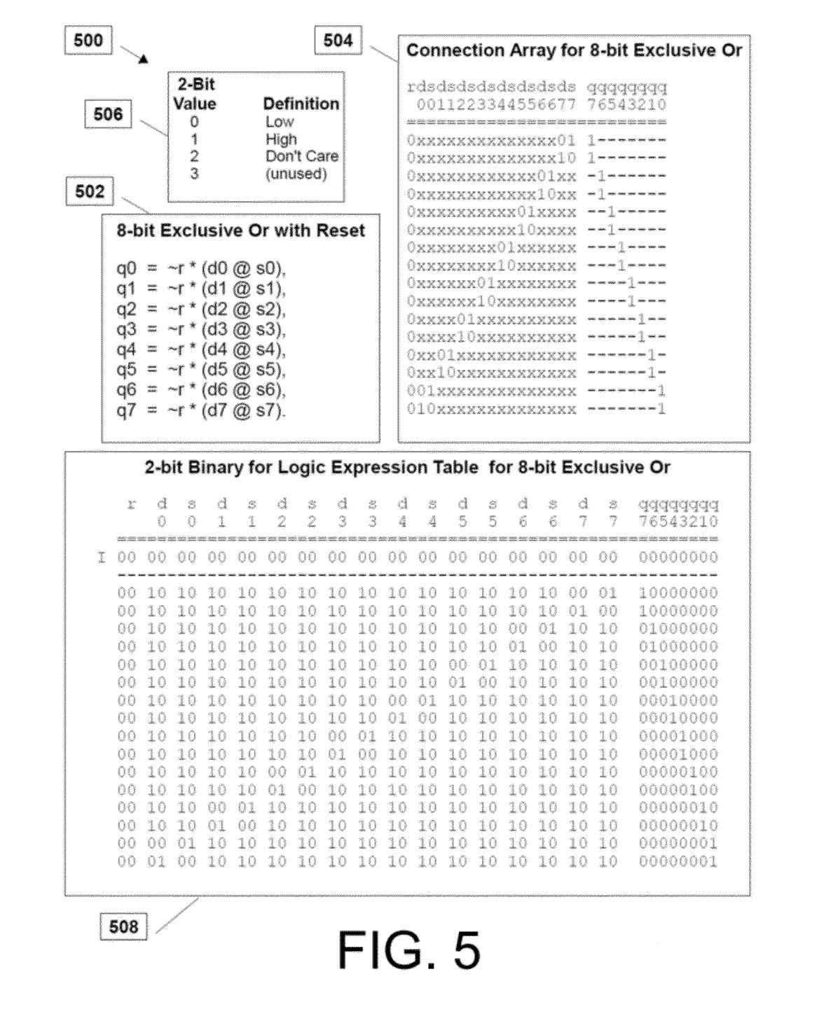

FIG. 5 contains an example 500 of a 2-bit logic definition 506, a set of source equations of an 8-bit exclusive Or with a reset 502, a CAFE generated connection array 504, and a 2-bit binary Logic Expression Table (LET) 508.

In FIG. 5 we have a simple example of how source code in the form of some simple Boolean equations can be transformed into the LET using a simple logical construct. The LET when coupled with the BPU instruction to execute constitutes the synthetic machine instruction described above.

A per bit expression for the combinatorial synthesis of an 8-bit “exclusive or with reset” is shown 502 in CAFE syntax with the symbols “*”, “+”, “˜” and “@” corresponding to the operators “and”, “or”, “not” and “Exclusive Or” respectively. The “d”, “r” and “s” bits would be from a portion of the current state vector and the “q” bits would be a portion of the new state vector. CAFE (Connection Arrays From Equations, published by Donald P. Dietmeyer) was used to synthesize the connection array 504, which is an text notation for a Sum Of Products (SOP) form of equations. While similar to a truth table, the actual meaning of the entries is that on the right hand side, if there is a “1” in a column, then the product term on the left hand side applies to that output. As illustrated in this array q0=s0*˜d0*˜r+˜s0*d0*˜r.

For machine representation of the combinatorial, the system uses a similar 2-bit format 506 as for the state vector for the symbolic values of “0” and “1” but also support a “don't care” value. With this the connection array can be converted to a binary Logic Expression Table 508, which can be used as a sequential look up table in machine execution.

The LET includes an inversion mask (row “I”) 508, which allows individual bits of the inputs or the outputs of the LET to be expressed using inverted logic. This is useful on the output side because in many logic expressions, the number of product terms is smaller (fewer entries in the LET) if the output is solved for zeros instead of ones. For inputs or outputs it is convenient to allow all logic in the vector to propagate in a state that matches the polarity of the memory elements.

For purposes of clarity, the column ordering generated by CAFE in the array 504 was maintained in the LET 508. In a embodiments, the LET may be generated by the compiler such that the “s” and “d” bits would not be interleaved and would likely be in descending order.

The state vector resides in computational common memory and migrates to and from the ASP for processing into the next vector, the LET and any other methods of modeling logic structures is distributed and resides in the ASPs. At simulation initialization, the ASPs local RAM 304 are loaded with software and LETs and programmed with their assigned sections of the state vector.

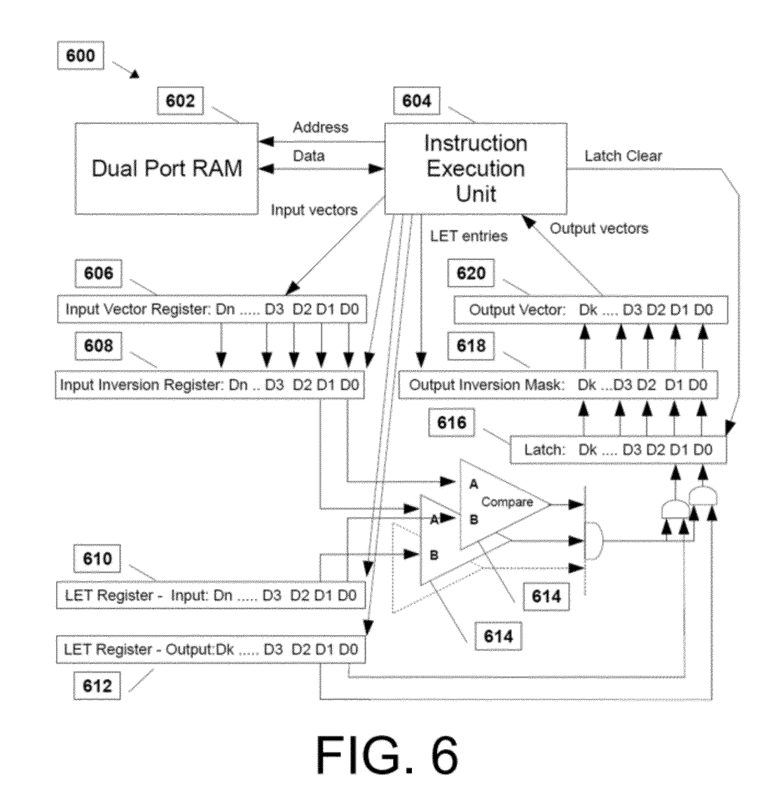

FIG. 6 contains the BPU 600 components comprised of dual port RAM 602, Instruction Execution Unit 604, input vector register 606, input inversion register 608, LET register for inputs 610, LET register for outputs 612, logic comparators 614, output latch 616, output inversion mask 618 and output vector register 620.

In FIG. 6 is shown how the synthetic machine instruction of executing the LET in the PTLC may work in some embodiments. Other instructions a BPU might also be able to perform are not diagrammed here.

The simplified diagram only shows one port of the Dual Port RAM 304,602, the Execution Unit 604 (which has some not shown features common to all ASPs), and the components of the Product Term Latching Comparator.

The Instruction Execution Unit (IEU) 604 may comprise a basic processor executing instructions from RAM like most other Von Neuman processors to move data between RAM and internal registers as well as to perform the functions for which the ASP is designed. Though the sophistication levels of ASPs containing a Product Term Latching Comparator (PTLC) can vary considerably, usually with many additional non-PTLC components, only the PTLC components are shown here for clarity.

The diagram is symbolic given that the actual bit representation is not shown. PLTCs can be built with 2-bit, 3-bit or larger representations of the state vector bits. The input inversion mask 608, the output inversion mask 618, and the LET outputs are all single bit per bit representations. The latch register is 2-bits per bit and the output vector may be equal to or larger than 2-bit per bit representation.

There is no reason for the number of input bits (n) or output bits(k) that make up the PTLC. There are some practical physical limits. At the low end, when a PTLC is used in conjunction with a Real Time Processing Unit (RTPU) the simulated gate delays are for real gates of usually 5 or less inputs and single outputs so the PLTC bit width is likely to be small. For idealized RTL (Boolean) simulation, the physical size can be quite large and determined by other physical properties such as VSS bus size or RAM port width.

The IEU has an instruction set that can move whole n-bit words from RAM to the Input Vector Register 606 or from the Output Vector Register 620 back to RAM. Being that this is the most efficient method, advanced compilers used in conjunction with this system may “pack” LETs along with packing composite vectors into whole words for fast execution. The IEU also contains lesser bit moves to the extent that vector registers can be loaded and unloaded with individual vector elements.

An example operation may include: 1) one or more software instructions to load the input Vector register 606 from RAM 602; 2) one or more software instructions to execute a LET at a specific RAM address 602; and/or 3) one or more software instructions to move the contents of the Output Vector Register 620 back into RAM 602.

The state machine within the IEU that executes the LET may be configured to: 1) Clear the status latch 616; 2) load the input inversion register 608; 3) load the output inversion register; and/or 4) sequentially load each LET entry into the Input register 610 and output register 612 until the list is exhausted.

Each 2-bit element of the status latch 616 may be initialized to an “unmatched” status. The comparators 614 on a symbolic bit-by-bit basis may be configured to test the input vector to see if it matches the LET input register. Three possible results may include “unmatched”, “matched” or “undefined”. The “don't care” LET input matches any possible input including “undefined”. All of the comparator outputs may be “anded” so that all of the comparators show a “matched” condition for there to be a product term match.

If there is a product term match, the LET output register 612 acts as an enable to route the status of the match to the latch 616. It is referred to as a “latch” since once set to a status of “matched” it may not be cleared till the next new LET evaluation. If the latch is set to “undefined” it may retain this value as well unless overridden by a matched condition.

While the LET is being evaluated and the latch 616 is taking on its final values, the Output Inversion Mask may be applied and a new value, the Output Vector Register 620, may be created.

Being software based, the IEU 604 can be programmed to handle multiple LETs and multiple sets of input vectors. The IEU 604 may be limited by RAM 602 capacity. Furthermore RAM 602 can be utilized by IEU software to support intermediate values. This is useful computation of terms common to more than one LET as input. An example of this is “wide decoding”. The width of the PTLC can be much smaller than the width of a word to be evaluated. The word is evaluated in more than one step in PTLC sized portions with results being passed on to the next step.

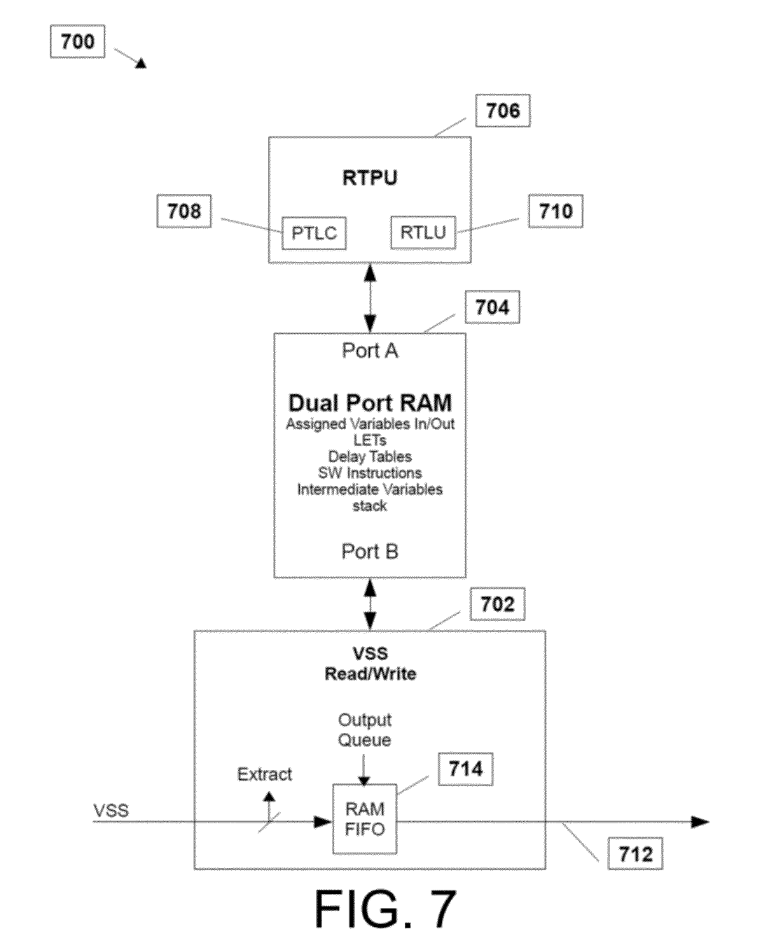

FIG. 7 presents one stage of a Real Time Processing Unit (RTPU) array 700 which contains the VSS read/write interface 702, a RAM based FIFO 714, dual port RAM 704, the RTPU 706 which contains its own PTLC 708 and an Real Time Look Up (RTLU) engine 710.

In FIG. 7 is presented an expanded functionality of the Boolean ASP into a Real Time Processing ASP. The BPU 306 is converted to an RTPU 706 by the addition of an RTLU engine that uses delay tables stored in RAM 704. The delay tables contain propagation time in terms of pre-defined units.

As described above, the PTLC 708 may be substantially similar to that in the BPU except may be much smaller. Real-time issues are more directed at synthetic primitives such as 2-input nand gates of gate-arrays or 4 to 6 input look up table RAMs in FPGAs. A combinatorial tree of many physical gates may be represented by a set of small LETs and delay tables for each signal path.

The input vector format may be identical to the Boolean ASP but the output vector can be different. In a Boolean Compatible Format (BCF) output, the calculated, or look-up, time delays determine in which vector cycle (each vector cycle represents one simulation clock cycle) the output changes. A calculated delay that violates set-up or hold for the technology at a clock edge can generate an “unknown” as an output. The BCF output may generate the correct real-time response but the timing details are hidden from any other analysis.

To support a more conventional real-time simulation environment the Real Time Format (RTF) may be different than the Boolean compatible input. In any given simulation cycle the RTF outputs may be combined with Boolean output by simulation host software to calculate the next state. Since timing information is preserved for Host Software, more detailed analysis can be done at the penalty of a slower simulation cycle.

Since input and output are marked by delimiters and occur in separate phases of the simulation cycle the mixture of Boolean input, BCF output and RTF output are still compatible with the VSS 712 bus behavior.

The Real Time ASP may contain an added component in the VSS Read/Write module 702 which is a RAM base FIFO 714. Unlike the Boolean ASP the RTF outputs may be marked with a time of change. After RTF outputs have been calculated they may be put in time order in an output queue with time markers. During an output phase, time marker delimiters on the VSS 712 bus stimulate the VSS Read/Write module 702 to insert an output result into the VSS stream.

Before any RTF output is inserted the FIFO 714 may have a depth of 1. Inserting 1 output result delays the VSS 712 input of the FIFO 714 by one entry and the FIFO may then have a depth of 2. In some embodiments, for a Real Time ASP programmed to generate N RTF outputs the FIFO may have a maximum depth of N+1.

Depth control is accomplished by the FIFO 714 being constructed of a circular buffer in ram with a separate input pointer and output pointer. When the FIFO 714 is empty both pointer values are identical. The “Depth” may be defined as the number values written to the FIFO 714 that have not yet been output.

The combination of a small amount of sorting in the RTPU and the ability to insert output into the stream in time order results in eliminating the need to sort all of the results in common memory. This simplifies the merging of real time results into the next state vector by host software.

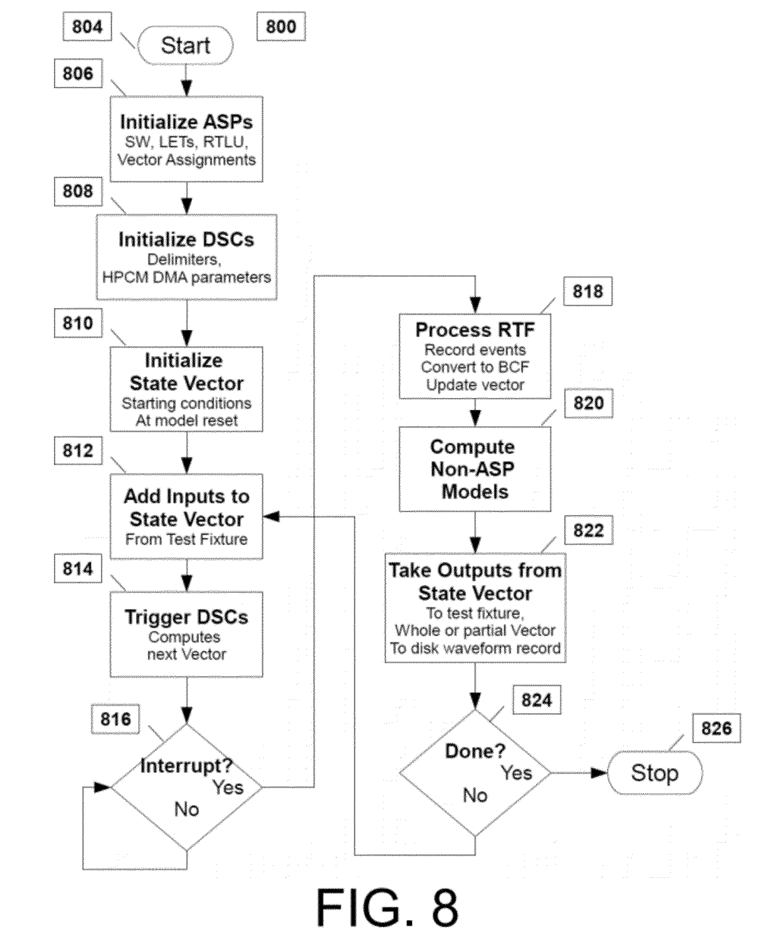

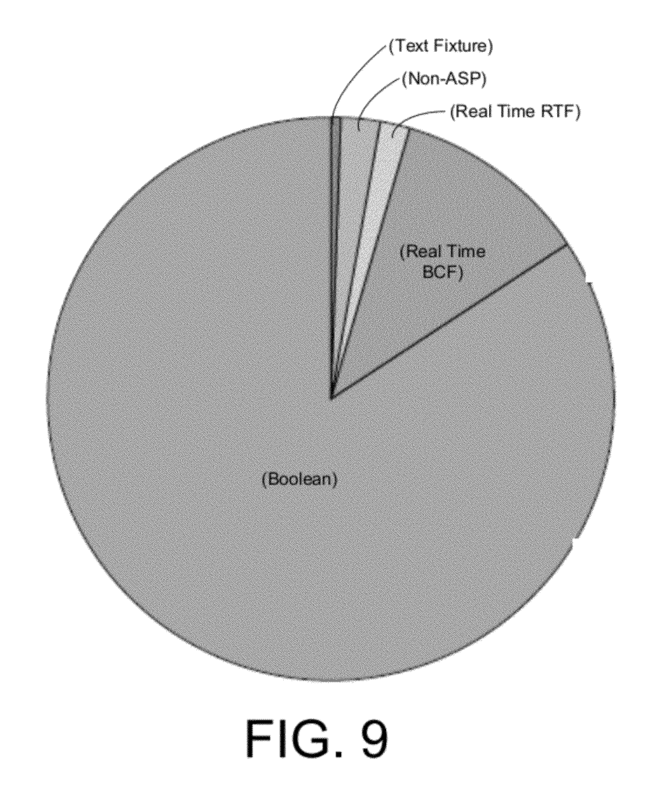

FIG. 8 and FIG. 9 present an embodiment of the simulation environment 800 which may contain a pie chart of a mixed mode model as shown in FIG. 9, and a flow chart as shown in FIG. 8, including a start 804, initialization of ASPs 806, initialization of DSCs, initialization of state vector 810, adding inputs 812, triggering DSCs 814, waiting for interrupt 816, Process RTF 818, Compute non-ASP models 820, take outputs 822, Done 824 and stop 826.

In FIG. 8 is presented a flow chart of how the overall simulation engine is managed by the host as well as a pie chart 802 of how much a typical simulation model is covered by embodiments of this disclosure. The pie chart in FIG. 9 provides context to understand the scope of the simulation and its effect on host processing of the state vector and the overall speed of simulation.

For purposes of clarity, the scope of chart in FIG. 9 is also limited to the ASPs presented in this disclosure. There are no restrictions on the sophistication of an ASP and many other types possible for accelerated simulation. For models not covered by the present ASPs, we'll assume the models to be supplied by host software and are denoted as Non-ASP portions of the model in the chart in FIG. 9.

Further, at the boundaries of the model there are test fixture interfaces which make up the I/O boundaries for the application of stimulus and the gathering of results. The pie chart in FIG. 9 represents, in proportion, of the computational work involved in each simulation cycle.

The flow chart in FIG. 8 shows the steps which may implement a mixed mode simulation of real-time and Boolean modeling on a cycle-by-cycle basis. Since a focus of this disclosure is on state vector computing, details of the simulation environment (test fixtures, user inputs, display outputs, etc.) will not be presented. The scope of this flow chart is oriented toward the scenario of a PCI plug-in simulation engine as presented in other figures but this strategy is extensible to more complex hardware architectures such as blades system and large customized HPC solutions.

To set up the model for simulation, host software may go through a number of initialization steps which have been summarized here as initializing ASPs 806, the DSCs 808 and the State Vector 810 to its initial conditions. The order of these operations isn't necessarily in the order shown and may depend on the exact machine architecture. Also since ASP components can be implemented in both FPGA (Field Programmable Gate Arrays) and ASICs (Application Specific Integrated Circuits) initialization may involve not shown steps of programming FPGAs to specific circuit designs and/or polling ASICs for their ASP type content.

The initialization of the ASPs 806 is the partitioning of the physical model among the ASPs available by loading software, LETs, RTLU and whatever else is needed to make up what is known in the industry as one or more “instantiations” of a logic model. The “soft” portion of the instantiation is the LETs, delay tables, ASP software, etc that make up re-usable logic structure. A “hard” instantiation is the combination of the soft instantiation with an assigned portion of the state vector that is used by the soft instantiation. Replication of N modules in a design is the processing of N portions of the state vector by same soft instantiation.

Host software initialization of the Data Stream Controllers (DSCs) 808 is the process of setting up DMA-like (Direct Memory Access) streams of vectors to and from the High Performance Computational Memory (HPCM 210). This is done in conjunction with initialization of the state vector 810 since there is a partitioning of the state vector among the ASPs on any given DSC and among the multiple DSC and their ASP arrays that may be a part of the system. Partition affects the organization of the vector elements in computational memory where the initial values of these elements reflect the state of the model at the beginning of the complete simulation (an initial point where the global reset is active).

The simulation cycle, which represents the computation of the next state, starts with the applications of inputs by host software from the test fixture 812. This input may be from specifically written vectors in whatever available HDL (High-level Description Language), from C or other language interfaces, data from files, or some real-world stimulus. Whatever the source, inputs may be converted into vector elements in a format detailed in FIG. 4 as one or more complete or part of one or more composite vectors.

The host software may then trigger the DSCs 814 which send out the complete current state vector from computational memory to all the systems ASPs where it gets processed and the DSCs receives back into computational memory a nearly complete new state vector. The end of this process generates a host interrupt 816 upon completion. The host software completes the processing of the new state vector by integrating real-time data in RTF form 818 into BCF form, and computing models not covered by ASPs 820. As described herein, RTF form real-time information is more for the use of additional analysis and diagnostics and becomes, in addition to a source of next vector information, a portion of the state vector outputs 822 so that the real time of state transition can be reported to the simulation environment or recorded.

In simulation environments state vector output 822 may be used for a variety of purposes such as waveform displays, state recording to disk, monitoring of key variables and the control and management of breakpoints. After a simulation computational cycle, host software examines vector locations in computational memory to extract whatever information may be necessary.

By way of comparison, in sophisticated high performance embodiments, the host software management of breakpoints and state vector extraction may become a control bottleneck to overall performance. It is likely that breakpoint ASPs and high-speed data channels from computational memory to mass storage media and other mechanism could be deployed for better vector I/O performance.

The simulation process, as a series of cycles, is “done” 824 as indicated by a breakpoint condition or that we have completed the amount of simulation cycles requested by the simulation environment. If we are “done”, the host software may finish up with all the simulation post processing to complete session displays and controls in the simulation environment as presented to the user. If we are not “done”, the host software may advance minimal feedback to the user and we start a new cycle with new vector inputs.

Not illustrated in the flow chart, but further contemplated, is the probability of other processing that may comprise part of the simulation cycle. One processing type not shown is “vector patching” which is the relocation or replication of computed vector components to facilitate the mapping of the inputs and outputs of various pieces of the simulation model. Patching could be done by host software (for example—in the Add Inputs step 812), DSC-like machines operating from computational memory, or special ASPs. This and other processing that may comprise part of the simulation cycle may be performed in some embodiments, as will be appreciated.

The foregoing detailed description has set forth various embodiments of example devices and/or processes. It will be understood by those within the art that each function and/or operation within such example devices and/or processes may be implemented, individually and/or collectively, by a wide range of hardware, software, firmware, or virtually any combination thereof. Some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Designing the circuitry and/or writing the code for the software and or firmware would be within the skill of one of skill in the art in light of this disclosure.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A distributed system for processing a simulation model among one or more application specific processors, the system comprising;
a host processor;
a data stream controller configured to support one or more deterministic data bus;
a high-performance computational memory coupled to at least one of a host processor and a data stream controller; and
at least one of an application specific processor configured to process Boolean logic or/and an application specific processor configured to process real-time logic.

2. The system of claim 1 wherein the Boolean logic processor comprises a product term latching comparator.

3. The system of claim 1 wherein the Boolean logic processor is configured to provide modeling of logic constructions.

4. The system of claim 1 wherein the real time logic processor comprises a product term latching comparator.

5. The system of claim 1 wherein the real-time logic processor is configured to provide modeling of logic constructions with actual silicon delay times.

6. The system of claim 4 wherein the real-time logic processor is further configured to perform real-time look-ups to determine timing of logic propagation and transition.

7. The system of claim 1 wherein the data stream controller, Boolean logic processor and real-time logic processor comprise a Field Programmable Gate Array.

8. The system of claim 1 wherein the data stream controller, Boolean logic processors and real-time logic processors comprise an Application Specific Integrated Circuit.
